(19) United States
(12) Patent Application Publication
(10) Pub. No.: US 2023/0128541 A1
(43) Pub. Date: Apr. 27, 2023

(54) WATER DIVERSION VALVE AND SHOWER DEVICE

(71) Applicant: FUJIAN XIHE SANITARY WARE TECHNOLOGY CO., LTD, Fujian (CN)

(72) Inventors: Xiaofa LIN, Fujian (CN); Xiaoshan LIN, Fujian (CN); Zhigang WAN, Fujian (CN); Xiaoqing DENG, Fujian (CN); Qiqiao LIU, Fujian (CN)

(73) Assignee: FUJIAN XIHE SANITARY WARE TECHNOLOGY CO., LTD, Fujian (CN)

(21) Appl. No.: 17/839,730

(22) Filed: Jun. 14, 2022

(30) Foreign Application Priority Data
Oct. 22, 2021 (CN) 202111233850.2

(51) Int. Cl. F16K 11/16; E03C 1/04; F16K 15/02

(52) U.S. Cl. CPC F16K 11/161; E03C 1/0408; F16K 15/026

(57) ABSTRACT

A water diversion valve includes: a valve main body; a reset assembly including a reset rod movably installed to the valve main body; a slider movably connected with a water diversion valve rod and the reset rod; and a button assembly in transmission fit with the slider. The slider can be switched between a first slider position to a fourth slider position under the driving of the reciprocating button assembly and the reciprocating reset rod, and can drive the water diversion valve rod to switch between a first water diversion position and a second water diversion position.

### CROSS-REFERENCE TO RELATED APPLICATION

This application claims foreign priority benefits under 35 U.S.C. § 119(a)-(d) to Chinese Patent Application No. 202111233850.2, filed on Oct. 22, 2021, which is hereby incorporated herein by reference in its entirety.

### TECHNICAL FIELD

The present application relates to, but is not limited to, a water diversion valve and a shower device including the water diversion valve.

### BACKGROUND

The water diversion valve is a common water diversion device in the field of bathroom, which is often installed on a rigid pipe of a shower and used to divide one water outflow passage of a shower faucet into at least two water outflow passages, one water outflow passage of which is used to be communicated with an over-head shower and the other water outflow passage of which is used to be communicated with a hand-held shower.

An axially movable valve rod is employed in the existing pressing waterway valve to open or close the waterway. However, such pressing waterway valve does not have a function of water diversion.

### SUMMARY

The following is a summary of the subject matter described in detail herein. This summary is not intended to limit the protection scope of the claims.

A water diversion valve includes: a valve main body having a water inlet, a first water outlet and a second water outlet; a water diversion valve rod movably installed to the valve main body; a reset assembly including a reset rod movably installed to the valve main body; a slider movably installed to the valve main body and movably connected with the water diversion valve rod and the reset rod; and a button assembly being in transmission fit with the slider. The slider is arranged to move from a first slider position to a second slider position under the driving of the button assembly and drive the water diversion valve rod to move from a first water diversion position to a second water diversion position, such that the water inlet is communicated with the second water outlet, and the slider is further arranged to move from the second slider position to a third slider position under the driving of the reset rod, such that the water diversion valve is switched from a first state to a second state. The slider is arranged to move from the third slider position to a fourth slider position under the driving of the button assembly and drive the water diversion valve rod to move from the second water diversion position to the first water diversion position, such that the water inlet is communicated with the first water outlet, and the slider is further arranged to move from the fourth slider position to the first slider position under the driving of the reset rod, such that the water diversion valve is switched from the second state to the first state.

A shower device includes a first water outflow component, a second water outflow component and the water diversion valve described above. The first water outflow component is communicated with the first water outlet of the water diversion valve, and the second water outflow component is communicated with the second water outlet of the water diversion valve.

Other features and advantages of the embodiments of the present application will be set forth in the following specification.

### BRIEF DESCRIPTION OF DRAWINGS

FIG. 1 is a schematic diagram of a three-dimensional structure of a water diversion valve according to an embodiment of the present application;

FIG. 2 is a front schematic structural diagram of the water diversion valve shown in FIG. 1;

FIG. 3 is a schematic exploded structural diagram of the water diversion valve shown in FIG. 1;

FIG. 4 is a schematic diagram of the three-dimensional structure of the valve main body of the water diversion valve shown in FIG. 1;

FIG. 5 is a front schematic structural diagram of the valve main body shown in FIG. 4;

FIG. 6 is a schematic structural diagram of the slider of the water diversion valve shown in FIG. 1;

FIG. 7 is a first schematic sectional structural diagram of the water diversion valve shown in FIG. 1 in a first state;

FIG. 8 is a second schematic sectional structural diagram of the water diversion valve shown in FIG. 1 in a first state;

FIG. 9 is a schematic diagram of the process of switching the water diversion valve shown in FIG. 1 from a first state to a second state;

FIG. 10 is a first schematic sectional structural diagram of the water diversion valve shown in FIG. 1 in a second state;

FIG. 11 is a second schematic sectional structural diagram of the water diversion valve shown in FIG. 1 in a second state; and

FIG. 12 is a schematic diagram of the process of switching the water diversion valve shown in FIG. 1 from a second state to a first state.

### REFERENCE NUMERALS

1: valve main body, 11: valve body, 12: valve cover, 121: protruding post, 13: guide rail, 14: water flow cavity, 141: first water flow branch, 15: water inlet, 16: first water outlet, 17: second water outlet,

2: water diversion valve rod, 21: first limiting portion, 22: second limiting portion,

31: reset rod, 311: third limiting portion, 312: fourth limiting portion, 32: first elastic member, 33: second elastic member,

4: slider, 41: first installing hole, 42: second installing hole, 43: second transmission portion, 431: third transmission ramp, 432: fourth transmission ramp, 44: sliding portion;

5: button assembly, 51: button, 511: first transmission portion, 5111: first transmission ramp, 5112: second transmission ramp, 52: third elastic member, 53: fixed seat.

### DETAILED DESCRIPTION

Embodiments of the present application will be described in detail below with reference to the accompanying drawings. It should be noted that the embodiments in the present application and the features in the embodiments may be combined with each other arbitrarily if there is no conflict.

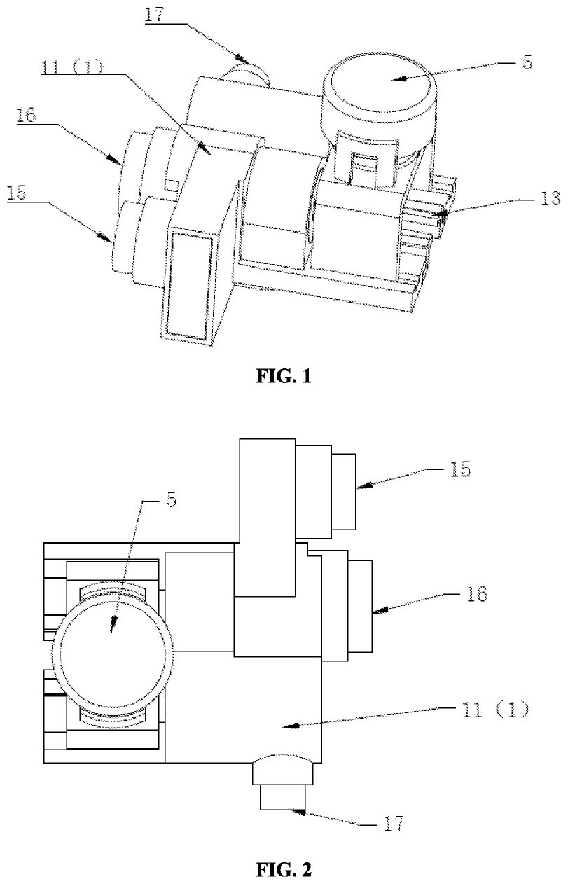

As shown in FIGS. 1 to 6, an embodiment of the present application provides a water diversion valve, which includes a valve main body 1, a water diversion valve rod, a reset assembly, a slider 4 and a button assembly 5.

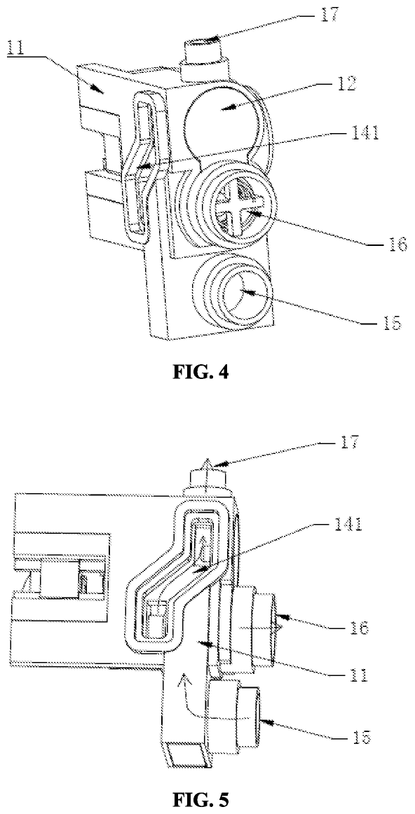

As shown in FIGS. 4 and 5, the valve main body 1 has a water inlet 15, a first water outlet 16 and a second water outlet 17.

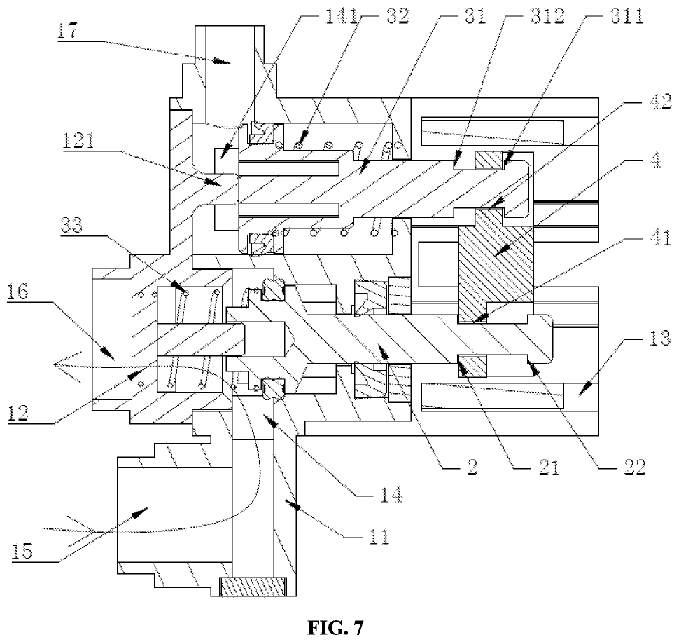

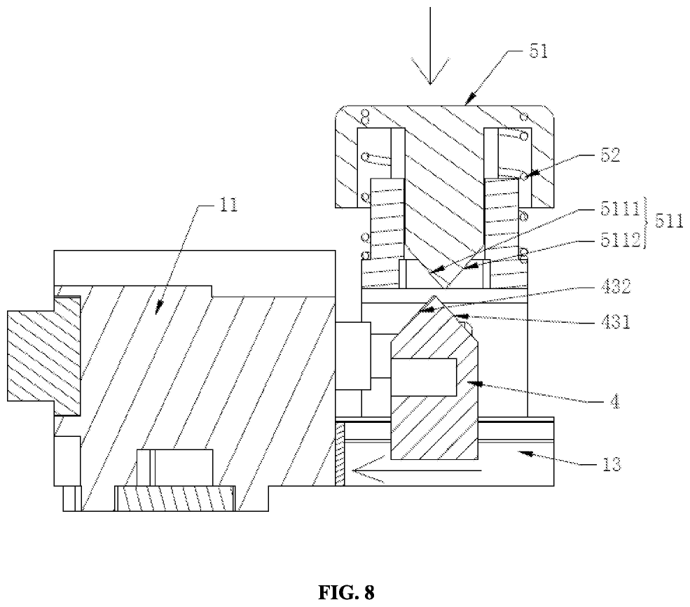

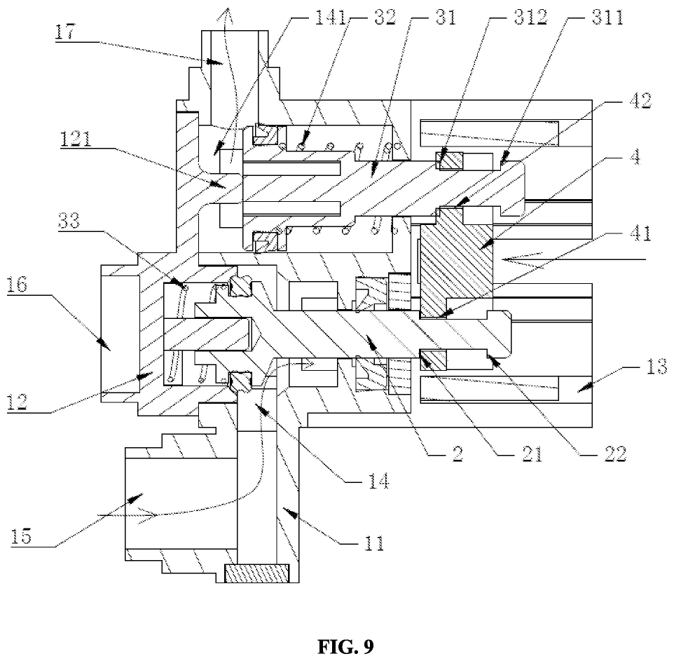

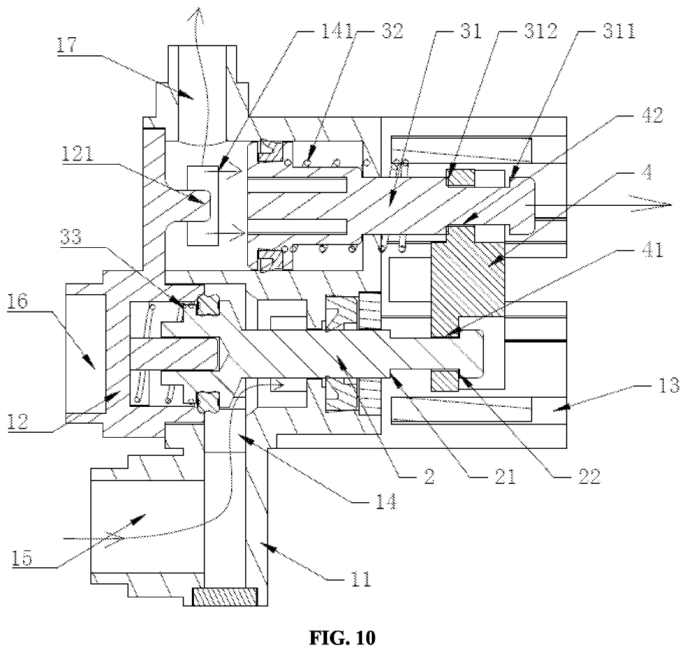

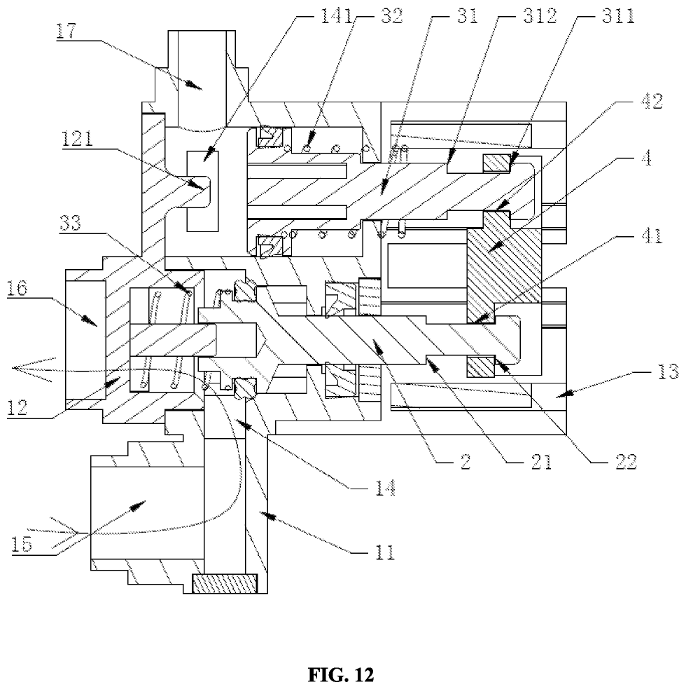

As shown in FIGS. 7-12, a water diversion valve rod 2 is movably installed to the valve main body 1. The water diversion valve rod 2 can reciprocate between a first water diversion position and a second water diversion position. As shown in FIGS. 7 and 12, when the water diversion valve rod 2 is in the first water diversion position, the water inlet 15 is communicated with the first water outlet 16. As shown in FIGS. 9 and 10, when the water diversion valve rod 2 is in the second water diversion position, the water inlet 15 is communicated with the second water outlet 17.

As shown in FIGS. 7-12, the reset assembly includes a reset rod 31 which is movably installed to the valve main body 1. The reset rod 31 can reciprocate between a first reset position (as shown in FIGS. 7 and 9) and a second reset position (as shown in FIGS. 10 and 12).

The slider 4 is movably installed to the valve main body 1 and movably connected with the water diversion valve rod 2 and the reset rod 31. The button assembly 5 is in transmission fit with the slider 4 (that is, the button assembly 5 can drive the slider 4 to move).

The slider 4 is arranged to move from a first slider position to a second slider position under the driving of the button assembly 5 and to drive the water diversion valve rod 2 to move from the first water diversion position to the second water diversion position, such that the water inlet 15 is communicated with the second water outlet 17. The slider 4 is further arranged to move from the second slider position to a third slider position under the driving of the reset rod 31, such that the water diversion valve is switched from a first state to a second state.

The slider 4 is further arranged to be movable from the third slider position to a fourth slider position under the driving of the button assembly 5 and to drive the water diversion valve rod 2 to move from the second water diversion position to the first water diversion position, such that the water inlet 15 is communicated with the first water outlet 16. The slider 4 is further arranged to move from the fourth slider position to the first slider position under the driving of the reset rod 31, such that the water diversion valve is switched from the second state to the first state.

In the water diversion valve, the slider 4 can move under the driving of the button assembly 5 and the reset rod 31, the water diversion valve rod 2 can move under the driving of the slider 4, and the water diversion valve can be switched between the first state and the second state by pressing the button assembly 5. Specifically, as shown in FIGS. 7 and 8, when the water diversion valve is in the first state (i.e., an initial state), the water diversion valve rod 2 is in the first water diversion position, such that the water inlet 15 of the valve main body 1 is communicated with the first water outlet 16 (a direction indicated by the curved arrow in FIG. 7 is a flow direction of water), the slider 4 is in the first slider position, and the reset rod 31 is in the initial position (i.e., the first reset position).

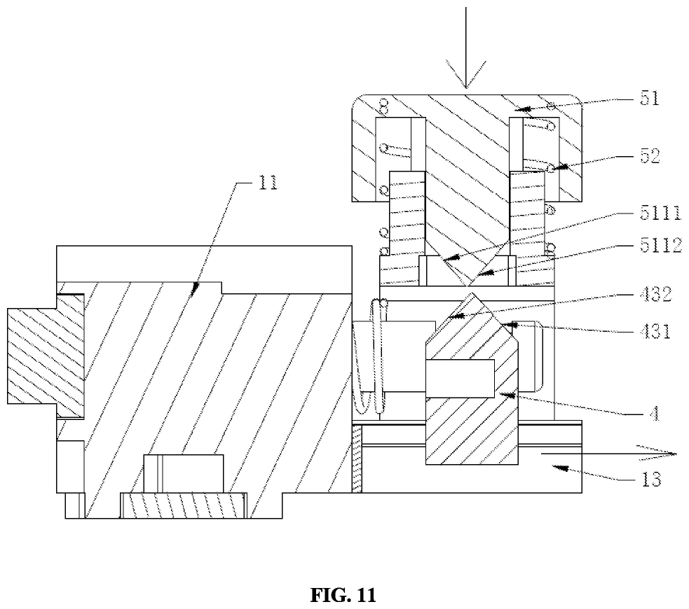

When the water diversion valve is in the first state shown in FIGS. 7 and 8, the button assembly 5 is pressed (the button assembly 5 moves along a downward arrow in FIG. 8), and the button assembly 5 drives the slider 4 to move from the first slider position shown in FIG. 7 to the second slider position shown in FIG. 9 (the slider 4 moves along a direction indicated by a leftwards arrow in FIG. 8), the slider 4 drives the water diversion valve rod 2 to move from the first water diversion position shown in FIG. 7 to the second water diversion position shown in FIG. 9 (at this point, the reset rod 31 moves relative to the slider 4, and the slider 4 does not drive the reset rod 31 to move), such that the water inlet 15 of the valve main body 1 is communicated with the second water outlet 17 (the direction indicated by the curved arrow in FIG. 9 is the flow direction of water). The reset rod 31 moves from the first reset position shown in FIG. 9 to the second reset position shown in FIG. 10, and drives the slider 4 to move from the second slider position shown in FIG. 9 to the third slider position shown in FIG. 10 (at this point, the water diversion valve rod 2 moves relative to the slider 4, and the slider 4 does not drive the water diversion valve rod 2 to move, such that the water diversion valve rod 2 is retained in the second water diversion position), such that the button assembly 5 can drive the slider 4 to move again, and prepare for the switch of the water diversion valve from the second state to the first state. At this point, the water diversion valve is switched from the first state shown in FIGS. 7 and 8 to the second state shown in FIGS. 10 and 11.

When the water diversion valve is in the second state shown in FIGS. 10 and 11, the button assembly 5 is pressed again (the button assembly 5 moves along a downward arrow in FIG. 11), the button assembly 5 drives the slider 4 to move (along a direction indicated by a rightwards arrow in FIG. 11) from the third slider position shown in FIG. 10 to the fourth slider position shown in FIG. 12, and the slider 4 drives the water diversion valve rod 2 to move and reset from the second water diversion position shown in FIG. 10 to the first water diversion position shown in FIG. 12 (at this point, the reset rod 31 moves relative to the slider 4, and the slider 4 does not drive the reset rod 31 to move), such that the water inlet 15 is restored to be communicated with the first water outlet 16. The reset rod 31 moves and resets from the second reset position shown in FIG. 12 to the first reset position shown in FIG. 7, and drives the slider 4 to move and reset from the fourth slider position shown in FIG. 12 to the first slider position shown in FIGS. 7 and 8 (at this point, the water diversion valve rod 2 moves relative to the slider 4, and the slider 4 does not drive the water diversion valve rod 2 to move, such that the water diversion valve rod 2 is retained in the first water diversion position), thus realizing the reset of the slider 4. At this point, the water diversion valve is switched from the second state shown in FIGS. 10 and 11 back to the first state shown in FIGS. 7 and 8.

The water diversion valve of the embodiment of the present application is a pressing water diversion valve. The switching between the first state and the second state of the water diversion valve is realized by pressing the button assembly 5, such that the water inlet 15 is communicated with the first water outlet 16 or the second water outlet 17, so as to divide the inflow water into two water outflow passages, and realize the water diversion function with simple operation.

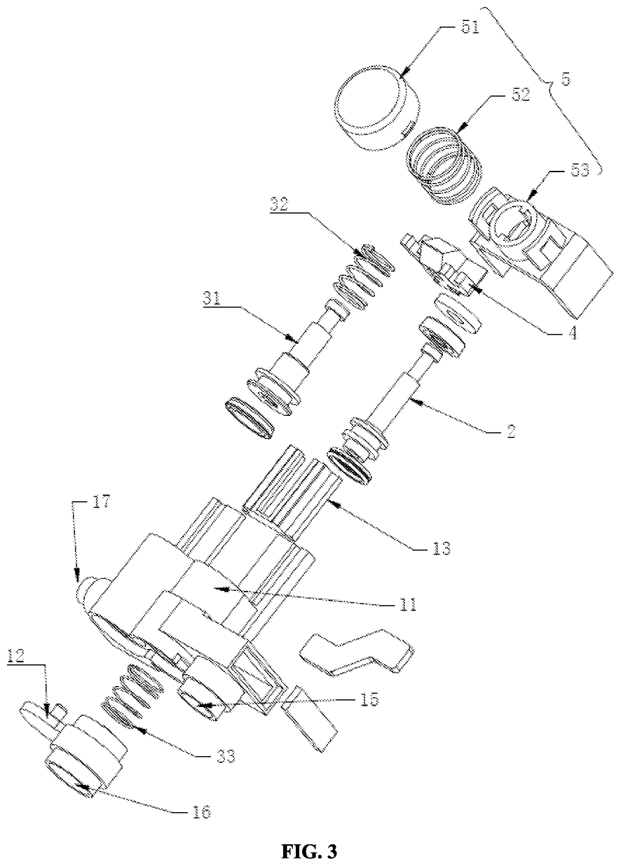

In some exemplary embodiments, as shown in FIGS. 3, 7-12, the reset assembly further includes a first elastic member 32. A part of the reset rod 31 extends into a first water flow branch 141 where the water inlet 15 is communicated with the second water outlet 17, and both ends of the first elastic member 32 abut against the reset rod 31 and the valve main body 1, respectively. The first elastic member 32 may be a spring.

The reset rod 31 is arranged to be movable from the first reset position shown in FIG. 9 to the second reset position shown in FIG. 10 against an elastic force of the first elastic member 32 under the action of water pressure, and to drive the slider 4 to move from the second slider position shown in FIG. 9 to the third slider position shown in FIG. 10. The reset rod 31 is further arranged to be movable from the second reset position shown in FIG. 12 to the first reset position shown in FIG. 7 under the elastic force of the first elastic member 32, and to drive the slider 4 to move from the fourth slider position shown in FIG. 12 to the first slider position shown in FIG. 7.

The part of the reset rod 31 extends into the first water flow branch 141 where the water inlet 15 is communicated with the second water outlet 17, such that the reset rod 31 is subjected to the action of the water pressure in the first water flow branch 141 when the water diversion valve is in the second state. The first elastic member 32 is arranged between the reset rod 31 and the valve main body 1, such that the reset rod 31 is subjected to the action of the elastic force of the first elastic member 32.

As shown in FIGS. 7 and 8, when the water diversion valve is in the first state, no water flows through the first water flow branch 141, hence the reset rod 31 is in the first reset position under the elastic force of the first elastic member 32. When the button assembly 5 is pressed (in the direction indicated by the downward arrow in FIG. 8), the slider 4 (moving in the direction indicated by the leftwards arrow in FIG. 8) moves from the first slider position to the second slider position and the water diversion valve rod 2 moves to the second water diversion position, as shown in FIG. 9, the water inlet 15 is communicated with the second water outlet 17. At this point, water flows through the first water flow branch 141, hence the reset rod 31 is subjected to the dual action of the water pressure and the elastic force of the first elastic member 32. The reset rod 31 moves from the first reset position shown in FIG. 9 to the second reset position shown in FIG. 10 against the elastic force of the first elastic member 32 under the action of water pressure. The reset rod 31 drives the slider 4 to move from the second slider position shown in FIG. 9 to the third slider position shown in FIG. 10. When the button assembly 5 is pressed again, the slider 4 moves from the third slider position to the fourth slider position (in the direction indicated by the rightwards arrow in FIG. 11) and the water diversion valve rod 2 moves and resets to the first water diversion position, as shown in FIG. 12, the water inlet 15 is restored to be communicated with the first water outlet 16. At this point, no water flows through the first water flow branch 141, hence the reset rod 31 moves and resets from the second reset position to the first reset position under the elastic force of the first elastic member 32, the reset rod 31 drives the slider 4 to move and reset from the fourth slider position to the first slider position.

The water diversion valve is a one-button, two-position water diversion valve with an automatic reset structure. Through the cooperation of the button assembly and water pressure, the water diversion valve rod 2 has two different water diversion positions, so as to realize the switching of waterways.

In some exemplary embodiments, as shown in FIGS. 3 and 7-12, the reset assembly further includes a second elastic member 33, and both ends of the second elastic member 33 abut against the water diversion valve rod 2 and the valve main body 1, respectively. The second elastic member 33 may be a spring.

The water diversion valve rod 2 is arranged to be retained in the first water diversion position (as shown in FIGS. 7 and 12) under the action of the second elastic member 33. The water diversion valve rod 2 in the second water diversion position (as shown in FIGS. 9 and 10) is arranged to overcome the elastic force of the second elastic member 33 under the action of water pressure to be retained in the second water diversion position.

The water diversion valve rod 2 is automatically retained in the first water diversion position under the action of the second elastic member 33, such that the water diversion valve is automatically retained in the first state in which the water inlet 15 is communicated with the first water outlet 16. The water pressure on the water diversion valve rod 2 contributes to keeping it in the first water diversion position after water is supplied. When the button assembly 5 is pressed and the water diversion valve rod 2 is moved from the first water diversion position to the second water diversion position under the driving of the slider 4, the water inlet 15 is communicated with the second water outlet 17. At this point, the water pressure acting on the water diversion valve rod 2 is opposite to the elastic force of the second elastic member 33, and the water diversion valve rod 2 overcomes the elastic force of the second elastic member 33 under the action of the water pressure to be retained in the second water diversion position, such that the water inlet 15 is retained to be communicated with the second water outlet 17. The water diversion valve in the second state can be switched back to the first state by pressing the button assembly 5. Alternatively, when water supply is stopped, the water diversion valve rod 2 is restored to the first water diversion position under the elastic force of the second elastic member 33, the reset rod 31 is restored to the first reset position under the action of the first elastic member 32, and the slider 4 is restored to the first slider position, such that the water diversion valve in the second state can be automatically reset to the first state after the water supply is stopped.

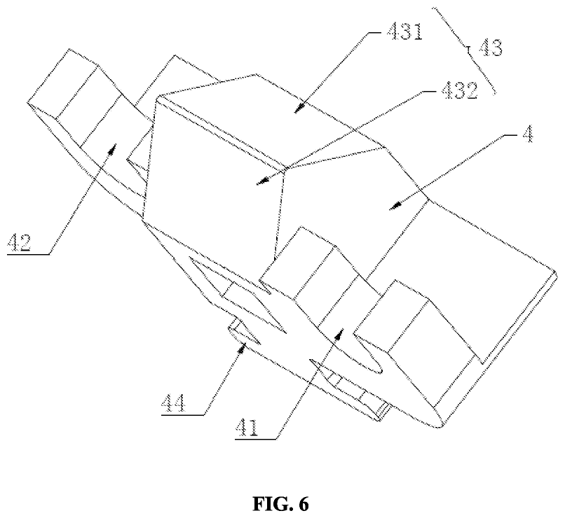

In some exemplary embodiments, as shown in FIGS. 6-12, the slider 4 is provided with a first installing hole 41 and a second installing hole 42. The water diversion valve rod 2 passes through the first installing hole 41 and can move relative to the first installing hole 41, and the water diversion valve rod 2 is provided with a first limiting portion 21 and a second limiting portion 22. The reset rod 31 passes through the second installing hole 42 and can move relative to the second installing hole 42, and the reset rod 31 is provided with a third limiting portion 311 and a fourth limiting portion 312.

As shown in FIG. 6, the slider 4 includes a first stopper and a second stopper. The first installing hole 41 is arranged in the first stopper, and the second installing hole 42 is arranged in the second stopper. The first limiting portion 21 and the second limiting portion 22 are protrusions integrally formed on the water diversion valve rod 2 and can abut against the first stopper, such that the slider 4 can drive the water diversion valve rod 2 to move. The third limiting portion 311 and the fourth limiting portion 312 are protrusions integrally formed on the reset rod 31 and can abut against the second stopper, such that the reset rod 31 can drive the slider 4 to move.

As shown in FIG. 7, when the water diversion valve is in the first state, the first limiting portion 21 of the water diversion valve rod 2 in the first water diversion position abuts against the slider 4, and the third limiting portion 311 of the reset rod 31 in the first reset position abuts against the slider 4.

When the slider 4 moves from the first slider position to the second slider position under the driving of the button assembly 5 and drives the water diversion valve rod 2 to switch from the first water diversion position to the second water diversion position, as shown in FIG. 9, the slider 4 in the second slider position abuts against the fourth limiting portion 312 of the reset rod 31. Specifically, the button assembly 5 is pressed when the water diversion valve is in the first state, the button assembly 5 drives the slider 4 to move from the first slider position to the second slider position, and the slider 4 can drive the water diversion valve rod 2 to switch from the first water diversion position to the second water diversion position, such that the water inlet 15 is communicated with the second water outlet 17 and disconnected from the first water outlet 16. At this point, the slider 4 does not drive the reset rod 31 to move, but moves relative to the reset rod 31, such that the slider 4 moved to the second slider position abuts against the fourth limiting portion 312 of the reset rod 31.

When the slider 4 moves from the second slider position to the third slider position under the driving of the reset rod 31, the slider 4 in the third slider position abuts against the second limiting portion 22 of the water diversion valve rod 2. After the water inlet 15 is communicated with the second water outlet 17 and disconnected from the first water outlet 16, the reset rod 31 moves from the first reset position to the second reset position against the elastic force of the first elastic member 32 under the action of water pressure, and the reset rod 31 can drive the slider 4 to move from the second slider position to the third slider position. At this point, the slider 4 does not drive the water diversion valve rod 2 to move, but moves relative to the water diversion valve rod 2, such that the slider 4 moved to the third slider position abuts against the second limiting portion 22 of the water diversion valve rod 2 (as shown in FIG. 10). Thus the water diversion valve rod 2 is retained in the second water diversion position and the water diversion valve is in the second state.

When the slider 4 moves from the third slider position to the fourth slider position under the driving of the button assembly 5 and drives the water diversion valve rod 2 to switch from the second water diversion position to the first water diversion position, the slider 4 in the fourth slider position abuts against the third limiting portion 311 of the reset rod 31. Specifically, the button assembly 5 is pressed when the water diversion valve is in the second state shown in FIG. 10, the button assembly 5 drives the slider 4 to move from the third slider position to the fourth slider position, and the slider 4 can drive the water diversion valve rod 2 to switch from the second water diversion position to the first water diversion position, such that the water inlet 15 is communicated with the first water outlet 16 and disconnected from the second water outlet 17. At this point, the slider 4 does not drive the reset rod 31 to move, but moves relative to the reset rod 31, such that the slider 4 moved to the fourth slider position abuts against the third limiting portion 311 of the reset rod 31 (as shown in FIG. 12).

When the slider 4 moves from the fourth slider position to the first slider position under the driving of the reset rod 31, the slider 4 in the first slider position abuts against the first limiting portion 21 of the water diversion valve rod 2. After the water inlet 15 is communicated with the first water outlet 16 and disconnected from the second water outlet 17, the reset rod 31 moves from the second reset position to the first reset position under the elastic force of the first elastic member 32, and the reset rod 31 can drive the slider 4 to move from the fourth slider position to the first slider position. At this point, the slider 4 does not drive the water diversion valve rod 2 to move, but moves relative to the water diversion valve rod 2, such that the slider 4 moved to the first slider position abuts against the first limiting portion 21 of the water diversion valve rod 2. Thus the water diversion valve rod 2 is retained in the first water diversion position and the water diversion valve is in the first state.

In some exemplary embodiments, as shown in FIGS. 6-12, the first installing hole 41 and the second installing hole 42 are arranged in juxtaposition and are parallel in an axial direction. The water diversion valve rod 2 and the reset rod 31 are arranged in juxtaposition and are parallel in the axial direction. The first limiting portion 21 and the fourth limiting portion 312 are located at one end along the axial direction of the first installing hole 41 and the second installing hole 42, and the second limiting portion 22 and the third limiting portion 311 are located at the other end along the axial direction of the first installing hole 41 and the second installing hole 42.

The first installing hole 41 and the second installing hole 42 are arranged in juxtaposition and are parallel in the axial direction. Accordingly, the water diversion valve rod 2 and the reset rod 31 are arranged in juxtaposition and are parallel in the axial direction, such that the first installing hole 41, the second installing hole 42, the water diversion valve rod 2 and the reset rod 31 are parallel in the axial direction. Such arrangement is advantageous for reducing the size of the water diversion valve along the axial direction of the first installing hole 41, the second installing hole 42, the water diversion valve rod 2 and the reset rod 31, realizing the compact arrangement of the water diversion valve rod 2 and the reset rod 31 and the miniaturization of the water diversion valve.

As shown in FIGS. 7-12, the first limiting portion 21 and the fourth limiting portion 312 are located at same end along the axial direction of the first installing hole 41 and the second installing hole 42, and the second limiting portion 22 and the third limiting portion 311 are located at the other end along the axial direction of the first installing hole 41 and the second installing hole 42. Such arrangement is advantageous for realizing the movable connection between the slider 4 and the water diversion valve rod 2 and the reset rod 31, such that the slider 4 is able to move relative to the water diversion valve rod 2 or drive the water diversion valve rod 2 to move together, and the slider 4 can move relative to the reset rod 31 or move together under the driving of the reset rod 31. Thus, the slider 4 can be switched between the first slider position to the fourth slider position under the driving of the reciprocating button assembly 5 and the reciprocating reset rod 31, and can drive the water diversion valve rod 2 to switch between the first water diversion position and the second water diversion position.

In some exemplary embodiments, as shown in FIGS. 3 and 7-12, the button assembly 5 includes a button 51, which is provided with a first transmission portion 511 and can reciprocate along a first direction. The slider 4 is provided with a second transmission portion 43 and can reciprocate along a second direction. The first transmission portion 511 cooperates with the second transmission portion 43 such that the button assembly 5 can drive the slider 4 to move. The first direction and the second direction are not parallel to each other. The first direction and the second direction may be perpendicular to each other. In FIGS. 8 and 11, the first direction may be an up and down direction and the second direction can be a left and right direction.

Compared with the slider 4 and the button 51 both moving in the first direction, the button 51 and the slider 4 in the embodiments of the present application move in the first direction and the second direction, respectively, which avoids the sequential arrangement of the slider 4 and the button 51 in the first direction, and further avoids the excessive size of the water diversion valve in the first direction. The button 51 and the slider 4 move along the first direction and the second direction, respectively, such that the compact arrangement of the slider 4 and the button 51 is advantageous for the miniaturization of the water diversion valve.

In some exemplary embodiments, as shown in FIGS. 8 and 11, the first transmission portion 511 includes a first transmission ramp 5111 and a second transmission ramp 5112, which are obliquely arranged with respect to the moving direction (first direction) of the button 51. As shown in FIGS. 6, 8 and 11, the second transmission portion 43 includes a third transmission ramp 431 and a fourth transmission ramp 432, which are obliquely arranged with respect to the moving direction (second direction) of the slider 4.

When the slider 4 is in the first slider position shown in FIG. 8, the third transmission ramp 431 is arranged to be in transmission fit with the first transmission ramp 5111, such that the button assembly 5 can drive the slider 4 to move to the second slider position along the second direction toward a first side (in the direction indicated by the leftwards arrow in FIG. 8). When the slider 4 is in the third slider position shown in FIG. 11, the fourth transmission ramp 432 is arranged to be in transmission fit with the second transmission ramp 5112, such that the button assembly 5 drives the slider 4 to move to the fourth slider position along the second direction toward a second side (in the direction indicated by the rightwards arrow in FIG. 8) opposite to the first side.

When the slider 4 is in the first slider position, the third transmission ramp 431 can be in transmission fit with the first transmission ramp 5111. At this point, the button 51 is pressed, and the button 51 can drive the slider 4 to move to the second slider position along the second direction toward the first side through the transmission fit of the first transmission ramp 5111 and the third transmission ramp 431. When the slider 4 moves from the second slider position to the third slider position under the driving of the reset rod 31, the fourth transmission ramp 432 can be in transmission fit with the second transmission ramp 5112. At this point, the button 51 is pressed, and the button 51 can drive the slider 4 to move to the fourth slider position along the second direction toward the second side through the transmission fit of the second transmission ramp 5112 and the fourth transmission ramp 432.

By providing the first transmission ramp 5111, the second transmission ramp 5112, the third transmission ramp 431 and the fourth transmission ramp 432, the movement of the button 51 along the first direction is converted into the movement of the slider 4 along the second direction.

In some exemplary embodiments, as shown in FIGS. 6, 8 and 11, the first transmission ramp 5111 and the second transmission ramp 5112 cooperate in a V shape, the third transmission ramp 431 and the fourth transmission ramp 432 cooperate in a V shape, and the tips of the two V shapes are oppositely arranged. The first transmission ramp 5111 and the fourth transmission ramp 432 are located on the same side, and the second transmission ramp 5112 and the third transmission ramp 431 are located on the other opposite side.

As shown in FIGS. 6, 8 and 11, the first transmission ramp 5111 and the fourth transmission ramp 432 are located on the left side facing the water diversion valve rod 2 and the reset rod 31, the second transmission ramp 5112 and the third transmission ramp 431 are located on the right side facing away from the water diversion valve rod 2 and the reset rod 31, and the second transmission portion 43 is located between the first installing hole 41 and the second installing hole 42. When the slider 4 is in the first slider position, by pressing the button 51 downward, the button 51 can drive the slider 4 to move leftwards to the second slider position through the transmission fit of the first transmission ramp 5111 and the third transmission ramp 431. When the slider 4 is in the third slider position, by pressing the button 51 downward, the button 51 can drive the slider 4 to move rightwards to the fourth slider position through the transmission fit of the second transmission ramp 5112 and the fourth transmission ramp 432.

In some exemplary embodiments, as shown in FIGS. 3, 8 and 11, the button assembly 5 further includes a third elastic member 52 and a fixed seat 53, and the button 51 is movably installed to the fixed seat 53. The third elastic member 52 is arranged between the button 51 and the fixed seat 53, and the fixed seat 53 can be fixedly connected with the valve main body 1.

In some exemplary embodiments, as shown in FIGS. 3 and 7-12, the valve main body 1 includes a valve cover 12 and a valve body 11. The valve cover 12 and the valve body 11 cooperate to form a first water flow branch 141, and the valve cover 12 is provided with a protruding post 121 extendable into the first water flow branch 141.

The reset rod 31 is arranged to abut against the protruding post 121 under the action of the first elastic member 32, and can be separated from the protruding post 121 under the action of water pressure, such that the first water flow branch 141 always remains in communication with the second water outlet 17.

The reset rod 31 abuts against the protruding post 121, which prevents the first water flow branch 141 from being disconnected from the second water outlet 17 due to the abutting of the reset rod 31 against an inner wall surface of the first water flow branch 141. The arrangement of protruding post 121 retains the first water flow branch 141 always in communication with the second water outlet 17 whether the reset rod 31 is in the first reset position in which the reset rod 31 is abutted against the protruding post 121 or in the second reset position in which the reset rod 31 is separated from the protruding post 121, such that water can flow through the first water flow branch 141 after the water diversion valve rod 2 moves to the second water diversion position, and a water pressure is applied to the reset rod 31 to move the reset rod 31 to the second reset position.

In some exemplary embodiments, as shown in FIGS. 3 and 7-12, the valve cover 12 is provided with a first water outlet 16, the valve body 11 is provided with a water inlet 15 and a second water outlet 17, and the water flow cavity 14 in the valve body 11 can communicate with the water inlet 15 and the first water outlet 16, or can communicate with the water inlet 15 and the second water outlet 17. The water diversion valve rod 2 extends into the water flow cavity 14 and can cooperate with the water flow cavity 14 to realize the communication between the water inlet 15 and the first water outlet 16, or the communication between the water inlet 15 and the second water outlet 17. The water flow cavity 14 includes the foregoing first water flow branch 141.

In some exemplary embodiments, as shown in FIGS. 3 and 6-12, the valve main body 1 further includes a guide rail 13, and the slider 4 is provided with a sliding portion 44 (as shown in FIG. 6), which can cooperate with the guide rail 13 to guide the sliding of the slider 4.

In some exemplary embodiments, seals are sleeved on the water diversion valve rod 2 and the reset rod 31, so as to seal and cooperate with the water flow cavity 14 and prevent water leakage. The seals may include at least one of an 0-ring and a V-ring.

The working process of the water diversion valve according to the embodiment of the present application will be described below with reference to the accompany drawings.
I) As shown in FIG. 7, in the initial state (that is, the first state of the water diversion valve), the water diversion valve rod 2 is retained in the first water diversion position on the right side under the action of the second elastic member 33, such that the water inlet 15 is communicated with the first water outlet 16, and the reset rod 31 is in the first reset position under the action of the first elastic member 32 and abuts against the protruding post 121 of the valve cover 12. After the water is supplied, the water enters the water inlet 15 and then flows out of the first water outlet 16.
II) In the initial state, the slider 4 is in the first slider position. At this point, as shown in FIG. 8, the button 51 is pressed, and the first transmission ramp 5111 on the button 51 cooperates with the third transmission ramp 431 on the slider 4, such that the slider 4 moves leftwards.

During the movement of the slider 4 to the left to the second slider position shown in FIG. 8, the first stopper on the slider 4 cooperates with the first limiting portion 21 of the water diversion valve rod 2, and the water diversion valve rod 2 is pushed to move leftwards against the elastic force of the second elastic member 33, such that the water inlet 15 is communicated with the second water outlet 17, and the water diversion valve rod 2 is retained in the second water diversion position on the left side under the action of water pressure. During the movement of the slider 4 to the left to the second slider position, the reset rod 31 changes from the third limiting portion 311 abutting against the second stopper of the slider 4 to the fourth limiting portion 312 abutting against the second stopper of the slider 4.

At this point, water flows out of the second water outlet 17. At the same time the water pressure overcomes the elastic force of the first elastic member 32 and the reset rod 31 is pushed rightwards. During the movement of the reset rod 31 to the right to the second reset position shown in FIG. 10, the fourth limiting portion 312 on the reset rod 31 pushes the second stopper of the slider 4 to move rightwards to the third slider position. During the movement of the slider 4 to the right to the third slider position, the water diversion valve rod 2 changes from the first limiting portion 21 abutting against the first stopper of the slider 4 to the second limiting portion 22 abutting against the first stopper of the slider 4. At this point, the water diversion valve is in the second state.
III) When the water diversion valve is in the second state, as shown in FIG. 11, the button 51 is pressed again, and the second transmission ramp 5112 on the button 51 cooperates with the fourth transmission ramp 432 on the slider 4, such that the slider 4 moves rightwards to the fourth slider position.

The slider 4 is moved rightwards, and the first stopper on the slider 4 pushes the second limiting portion 22 of the water diversion valve rod 2 to move the water diversion valve rod 2 rightwards, such that the water inlet 15 is communicated with the first water outlet 16, and the water diversion valve rod 2 is retained in the first water diversion position on the right side under the action of the second elastic member 33, as shown in FIG. 12. During the movement of the slider 4 to the right to the fourth slider position, the reset rod 31 changes from the fourth limiting portion 312 abutting against the second stopper of the slider 4 to the third limiting portion 311 abutting against the second stopper of the slider 4.

At the same time, under the action of the first elastic member 32, the reset rod 31 moves leftward to the first reset position. While the reset rod 31 moves leftwards, the third limiting portion 311 on the reset rod 31 drives the slider 4 to move leftward to the initial first slider position, such that the water diversion valve is restored to the initial state shown in FIG. 7. At this point, a switching cycle of the water diversion valve is completed.
IV) When the water inlet 15 is switched to be communicated with the second water outlet 17 (that is, the water diversion valve is in the second state shown in FIG. 10), the water supply is stopped. At this point, the water pressure in the first water flow branch 141 disappears, and the reset rod 31 moves leftwards and resets to the first reset position under the action of the first elastic member 32.

At this point, due to the disappearance of the water pressure, the water diversion valve rod 2 moves rightwards under the action of the second elastic member 33 and retains at the first water diversion position on the right side, and the water diversion valve rod 2, the reset rod 31 and the slider 4 are all reset to the initial state.

Once the water supply is turned on next time, the automatic default is that the water inlet 15 is communicated with the first water outlet 16.

An embodiment of the present application also provides a shower device including a first water outflow component, a second water outflow component and the water diversion valve provided by any of the above embodiments. The first water outflow component is communicated with the first water outlet of the water diversion valve, and the second water outflow component is communicated with the second water outlet of the water diversion valve.

Obviously, the water diversion valve is not limited to be applied to shower devices, but also can be applied to other products such as faucets.

According to the water diversion valve provided by the embodiments of the present application, the water inlet can be controlled to communicate with the first water outlet or the second water outlet by pressing the button assembly, such that the inflow water can be divided into two water outflow passages, and then the water diversion function can be realized.

In the water diversion valve, the slider can move under the driving of the button assembly and the reset rod, the water diversion valve rod can move under the driving of the slider, and the water diversion valve can be switched between the first state and the second state by pressing the button assembly. When the water diversion valve is in the first state (i.e. an initial state), the water diversion valve rod is in the first water diversion position, such that the water inlet of the valve main body is communicated with the first water outlet, the slider is in the first slider position, and the reset rod is in the initial position (i.e. the first reset position).

The button assembly is pressed, the button assembly drives the slider to move from the first slider position to the second slider position, and the slider drives the water diversion valve rod to move from the first water diversion position to the second water diversion position (at this point, the reset rod moves relative to the slider, and the slider does not drive the reset rod to move), such that the water inlet of the valve main body is communicated with the second water outlet. The reset rod moves from the first reset position to the second reset position, and drives the slider to move from the second slider position to the third slider position (at this point, the water diversion valve rod moves relative to the slider, and the slider does not drive the water diversion valve rod to move, such that the water diversion valve rod is retained in the second water diversion position), such that the button assembly can drive the slider to move again and prepare for the switch of the water diversion valve from the second state to the first state. At this point, the water diversion valve is switched from the first state to the second state.

The button assembly is pressed again, the button assembly drives the slider to move from the third slider position to the fourth slider position, and the slider drives the water diversion valve rod to move and reset from the second water diversion position to the first water diversion position (at this point, the reset rod moves relative to the slider, and the slider does not drive the reset rod to move), such that the water inlet is restored to be communicated with the first water outlet. The reset rod moves and resets from the second reset position to the first reset position, and drives the slider to move and reset from the fourth slider position to the first slider position (at this point, the water diversion valve rod moves relative to the slider, and the slider does not drive the water diversion valve rod to move, such that the water diversion valve rod is retained in the first water diversion position), thus realizing the reset of the slider. At this point, the water diversion valve is switched from the second state to the first state.

The water diversion valve of the embodiments of the present application is a pressing water diversion valve, and the switching between the first state and the second state of the water diversion valve is realized by pressing the button assembly, such that the water diversion function is realized with simple operation.

Although implementations disclosed in the present application are described above, the described contents are only implementations adopted for facilitating the understanding of the present application, and are not intended to limit the present application. Without departing from the spirit and scope disclosed in the present application, any person skilled in the art to which the present application pertains may make any modifications and changes in the forms and details of implementations, but the scope of patent protection of the present application shall still be defined by the appended claims.

What is claimed is:

1. A water diversion valve, comprising:
a valve main body having a water inlet, a first water outlet and a second water outlet;
a water diversion valve rod movably installed to the valve main body;
a reset assembly including a reset rod movably installed to the valve main body;
a slider movably installed to the valve main body and movably connected with the water diversion valve rod and the reset rod; and
a button assembly being in transmission fit with the slider;
wherein the slider is arranged to move from a first slider position to a second slider position under the driving of the button assembly and drive the water diversion valve rod to move from a first water diversion position to a second water diversion position, such that the water inlet is communicated with the second water outlet, and the slider is further arranged to move from the second slider position to a third slider position under the driving of the reset rod, such that the water diversion valve is switched from a first state to a second state; and
the slider is arranged to move from the third slider position to a fourth slider position under the driving of the button assembly and drive the water diversion valve rod to move from the second water diversion position to the first water diversion position, such that the water inlet is communicated with the first water outlet, and the slider is further arranged to move from the fourth slider position to the first slider position under the driving of the reset rod, such that the water diversion valve is switched from the second state to the first state.

2. The water diversion valve according to claim 1, wherein the reset assembly further comprises a first elastic member, a part of the reset rod extends into a first water flow branch where the water inlet is communicated with the second water outlet, and both ends of the first elastic member abut against the reset rod and the valve main body, respectively;
the reset rod is arranged to be movable from a first reset position to a second reset position against an elastic force of the first elastic member under the action of water pressure and drive the slider to move from the second slider position to the third slider position; the reset rod is further arranged to be movable from the second reset position to the first reset position under the action of an elastic force of the first elastic member and drive the slider to move from the fourth slider position to the first slider position.

3. The water diversion valve according to claim 2, wherein the slider is provided with a first installing hole and a second installing hole, the water diversion valve rod passes through the first installing hole and is able to move relative to the first installing hole, and the water diversion valve rod is provided with a first limiting portion and a second limiting portion; the reset rod passes through the second installing hole and is able to move relative to the second installing hole, and the reset rod is provided with a third limiting portion and a fourth limiting portion;
when the water diversion valve is in the first state, the first limiting portion of the water diversion valve rod in the first water diversion position abuts against the slider, and the third limiting portion of the reset rod in the first reset position abuts against the slider;
when the slider moves from the first slider position to the second slider position under the driving of the button assembly and drives the water diversion valve rod to switch from the first water diversion position to the second water diversion position, the slider in the second slider position abuts against the fourth limiting portion of the reset rod;
when the slider moves from the second slider position to the third slider position under the driving of the reset rod, the slider in the third slider position abuts against the second limiting portion of the water diversion valve rod;
when the slider moves from the third slider position to the fourth slider position under the driving of the button assembly and drives the water diversion valve rod to switch from the second water diversion position to the first water diversion position, the slider in the fourth slider position abuts against the third limiting portion of the reset rod; and
when the slider moves from the fourth slider position to the first slider position under the driving of the reset rod, the slider in the first slider position abuts against the first limiting portion of the water diversion valve rod.

4. The water diversion valve according to claim 3, wherein the first installing hole and the second installing hole are arranged in juxtaposition and are parallel in an axial direction;
the water diversion valve rod and the reset rod are arranged in juxtaposition and are parallel in the axial direction, the first limiting portion and the fourth limiting portion are located at one end along the axial direction of the first installing hole and the second installing hole, and the second limiting portion and the third limiting portion are located at the other end along the axial direction of the first installing hole and the second installing hole.

5. The water diversion valve according to claim 1, wherein the button assembly comprises a button provided with a first transmission portion and being capable of reciprocating along a first direction;
the slider is provided with a second transmission portion and is able to reciprocate along a second direction, the first transmission portion cooperates with the second transmission portion such that the button assembly drives the slider to move, and the first direction is not parallel to the second direction.

6. The water diversion valve according to claim 5, wherein the first direction is perpendicular to the second direction, and the first transmission portion comprises a first transmission ramp and a second transmission ramp, the second transmission portion comprises a third transmission ramp and a fourth transmission ramp,
when the slider is in the first slider position, the third transmission ramp is arranged to be in transmission fit with the first transmission ramp such that the button assembly drives the slider to move to the second slider position along the second direction toward a first side; when the slider is in the third slider position, the fourth transmission ramp is arranged to be in transmission fit with the second transmission ramp such that the button assembly drives the slider to move to the fourth slider position along the second direction toward a second side opposite to the first side.

7. The water diversion valve according to claim 6, wherein the first transmission ramp and the second transmission ramp cooperate in a V shape, the third transmission ramp and the fourth transmission ramp cooperate in a V shape, and tips of the two V shapes are oppositely arranged, the first transmission ramp and the fourth transmission ramp are located on the same side, and the second transmission ramp and the third transmission ramp are located on the other opposite side.

8. The water diversion valve according to claim 2, wherein the valve main body comprises a valve cover and a valve body, the valve cover and the valve body cooperate to form the first water flow branch, and the valve cover is provided with a protruding post extendable into the first water flow branch;
the reset rod is arranged to abut against the protruding post under the action of the first elastic member, and is able to be separated from the protruding post under the action of water pressure, such that the first water flow branch always remains in communication with the second water outlet.

9. The water diversion valve according to claim 1, wherein the reset assembly further comprises a second elastic member, and both ends of the second elastic member abut against the water diversion valve rod and the valve main body, respectively;
the water diversion valve rod is arranged to be retained in the first water diversion position under the action of the second elastic member, and the water diversion valve rod in the second water diversion position is arranged to overcome an elastic force of the second elastic member under the action of water pressure to be retained in the second water diversion position.

10. The water diversion valve according to claim 2, wherein the button assembly comprises a button provided with a first transmission portion and being capable of reciprocating along a first direction;
the slider is provided with a second transmission portion and is able to reciprocate along a second direction, the first transmission portion cooperates with the second transmission portion such that the button assembly drives the slider to move, and the first direction is not parallel to the second direction.

11. The water diversion valve according to claim 3, wherein the button assembly comprises a button provided with a first transmission portion and being capable of reciprocating along a first direction;
the slider is provided with a second transmission portion and is able to reciprocate along a second direction, the first transmission portion cooperates with the second transmission portion such that the button assembly drives the slider to move, and the first direction is not parallel to the second direction.

12. The water diversion valve according to claim 4, wherein the button assembly comprises a button provided with a first transmission portion and being capable of reciprocating along a first direction;
the slider is provided with a second transmission portion and is able to reciprocate along a second direction, the first transmission portion cooperates with the second transmission portion such that the button assembly drives the slider to move, and the first direction is not parallel to the second direction.

13. The water diversion valve according to claim 3, wherein the valve main body comprises a valve cover and a valve body, the valve cover and the valve body cooperate to form the first water flow branch, and the valve cover is provided with a protruding post extendable into the first water flow branch;
the reset rod is arranged to abut against the protruding post under the action of the first elastic member, and is able to be separated from the protruding post under the action of water pressure, such that the first water flow branch always remains in communication with the second water outlet.

14. The water diversion valve according to claim 4, wherein the valve main body comprises a valve cover and a valve body, the valve cover and the valve body cooperate to form the first water flow branch, and the valve cover is provided with a protruding post extendable into the first water flow branch;
the reset rod is arranged to abut against the protruding post under the action of the first elastic member, and is able to be separated from the protruding post under the action of water pressure, such that the first water flow branch always remains in communication with the second water outlet.

15. The water diversion valve according to claim 2, wherein the reset assembly further comprises a second elastic member, and both ends of the second elastic member abut against the water diversion valve rod and the valve main body, respectively;
the water diversion valve rod is arranged to be retained in the first water diversion position under the action of the second elastic member, and the water diversion valve rod in the second water diversion position is arranged to overcome an elastic force of the second elastic member under the action of water pressure to be retained in the second water diversion position.

16. The water diversion valve according to claim 3, wherein the reset assembly further comprises a second elastic member, and both ends of the second elastic member abut against the water diversion valve rod and the valve main body, respectively;
the water diversion valve rod is arranged to be retained in the first water diversion position under the action of the second elastic member, and the water diversion valve rod in the second water diversion position is arranged to overcome an elastic force of the second elastic member under the action of water pressure to be retained in the second water diversion position.

17. The water diversion valve according to claim 4, wherein the reset assembly further comprises a second elastic member, and both ends of the second elastic member abut against the water diversion valve rod and the valve main body, respectively;
the water diversion valve rod is arranged to be retained in the first water diversion position under the action of the second elastic member, and the water diversion valve rod in the second water diversion position is arranged to overcome an elastic force of the second elastic member under the action of water pressure to be retained in the second water diversion position.

18. A shower device comprising a first water outflow component, a second water outflow component and the water diversion valve according to claim 1, wherein the first water outflow component is communicated with the first water outlet of the water diversion valve, and the second water outflow component is communicated with the second water outlet of the water diversion valve.
